(19) United States
(12) Patent Application Publication
(10) Pub. No.: US 2012/0217741 A1
(43) Pub. Date: Aug. 30, 2012

(54) PIPE-HOSE ARRANGEMENT

(75) Inventor: Artem SERYI, Wiesbaden (DE)

(73) Assignee: GM GLOBAL TECHNOLOGY OPERATIONS LLC, Detroit, MI (US)

(21) Appl. No.: 13/372,747

(22) Filed: Feb. 14, 2012

(30) Foreign Application Priority Data
Feb. 24, 2011 (DE) 10 2011 012 376.8

(51) Int. Cl. F16L 33/02; B23P 11/00

(52) U.S. Cl. 285/242; 29/455.1

(57) ABSTRACT

A pipe-hose arrangement is provided having a pipe, a hose having a hose section facing toward the pipe that overlaps a pipe section facing toward the hose, which has a radial shoulder having an external diameter. A sleeve is also provided that has a sleeve, which at least partially overlaps the hose section on a side of the radial shoulder, which is axially opposite to a front side of the pipe facing toward the hose, and has a minimum internal diameter. The minimum diameter is smaller than the external diameter of the radial shoulder plus a wall thickness of the non-deformed hose section.

### CROSS-REFERENCE TO RELATED APPLICATION

This application claims priority to German Patent Application No. 10 2011 012 376.8, filed Feb. 24, 2011, which is incorporated herein by reference in its entirety.

### TECHNICAL FIELD

The technical field relates to a pipe-hose arrangement having a pipe and a hose fastened thereon as well as a method for producing such a pipe-hose arrangement.

### BACKGROUND

Hoses must be connected to pipes in particular in motor vehicles, for example, in a vehicle air conditioner. A connection of two pipes is known from WO 2010/028872 A1, in which an upset collar of one pipe is accommodated in a stepped hole of the other pipe. The front side of one pipe is axially supported on a shoulder of the stepped hole of the other pipe in such a manner that a ring space is provided between a further shoulder of the stepped hole and the upset collar, in which an O-ring can be accommodated without axial compression.

At least one object is to provide an advantageous pipe-hose arrangement. In addition, other objects, desirable features, and characteristics will become apparent from the subsequent summary and detailed description, and the appended claims, taken in conjunction with the accompanying drawings and this background.

### SUMMARY

A pipe-hose arrangement has a pipe, which comprises aluminum in a preferred embodiment, in particular is produced from aluminum or an aluminum alloy. The pipe is preferably dimensionally rigid, i.e., it has a modulus of elasticity of greater than approximately 1 kN/mm² A hose is fastened on the pipe, which comprises rubber, natural rubber, and/or plastic in a preferred embodiment, in particular elastomer and/or silicone, and is produced in particular from rubber, natural rubber, and/or a plastic. The hose is preferably flexible, i.e., it has a modulus of elasticity of less than approximately 1 kN/mm², preferably less than approximately 0.1 kN/mm².

A hose section of the hose facing toward the pipe overlaps a pipe section of the pipe facing toward the hose. Overlapping is generally understood in the present case in particular to mean that an overlapping part is arranged on the radial outside of an overlapped part, so that both parts overlap in at least one, preferably every axial section. Overlapped and overlapping parts preferably contact one another or radially spaced apart from one another.

The pipe section has at least one radial shoulder, preferably precisely one or two or more shoulders or projections each having an external diameter. An external diameter is generally understood in the present case in particular as a maximum extension in the radial direction, i.e., its diameter in the stricter sense in the case of a circular cross-section, or the diagonal in the case of a rectangular cross-section. A radial shoulder can extend with at least essentially uniform external diameter in a ring shape around the periphery of the pipe section. A radial shoulder can also have different diameters in the peripheral direction and/or extend only over one or more parts of the periphery. In a preferred embodiment, a radial shoulder is produced by axial compression of the hose section.

A pipe-hose arrangement also has a sleeve, which overlaps the hose section partially or on its entire axial length. The sleeve can protrude axially beyond the hose section on one or both sides. The hose section can similarly protrude axially beyond the sleeve on one or both sides. In a preferred embodiment, the sleeve comprises aluminum and is preferably made of aluminum or an aluminum alloy. The sleeve is preferably not elastically and/or plastically deformed, or at least not substantially, during fastening according to the invention of the hose on the pipe. The sleeve can preferably have a modulus of elasticity of greater than approximately 50 kN/mm².

The pipe, the hose, and/or the sleeve preferably each have a cross-section in the form of a circular ring, but can also have other cross-sections, in particular rectangular or polygonal cross-sections. In a section that at least partially overlaps the hose section, the sleeve has a minimum internal diameter, which is smaller than the external diameter of the or one radial shoulder plus a wall thickness of the non-deformed hose section, preferably smaller than the external diameter of the radial shoulder. An internal diameter is again generally understood in the present case in particular as a minimum extension of a recess, which accommodates the hose section, in particular a through hole, of the sleeve in the radial direction, i.e., the diameter of the recess or through hole in the case of a circular cross-section. In this way, the hose section is axially secured in a self-locking manner between sleeve and pipe section against pulling of the hose off the pipe. An axial tension on the hose away from the pipe displaces the sleeve together with the hose section overlapped thereby against the radial shoulder, and thus reduces the gap between minimum internal diameter of the sleeve and the external diameter of the radial shoulder and clamps the hose section between them.

Accordingly, to produce the pipe-hose arrangement, the hose section is moved axially over the radial shoulder, in particular pulled, and/or pushed. In a preferred refinement, the pipe section can be cooled and/or the hose section can be heated for this purpose. It is similarly possible to form the radial shoulder, in particular by axial compression, after the hose section has been moved axially over the pipe section.

The sleeve is moved on to the hose section, in particular pulled and/or pushed, from a side of the radial shoulder which is axially opposite to the front side of the pipe facing toward the hose. In an embodiment, the hose section can be cooled and/or the sleeve can be heated for this purpose. If the radial shoulder is formed, in particular by axial compression, after the hose section has been axially moved over the pipe section, the sleeve can also be moved onto the hose section before the application of the hose section to the pipe section. If the hose having applied sleeve is then axially moved toward the radial shoulder, a wall section of the hose is clamped in a self-locking manner between sleeve and pipe, since the minimum internal diameter of the sleeve overlapping the hose section is smaller than the external diameter of the radial shoulder plus a wall thickness of the non-deformed hose section, in particular smaller than the external diameter of the radial shoulder alone. An alternative, in particular simple, cost-effective, and reliable fastening can thus advantageously be produced.

In an embodiment, the sleeve has different internal diameters. In particular, the sleeve can at least partially overlap the radial shoulder. A recess of the sleeve that accommodates the hose section can preferably have an internal diameter in this axial section, which is smaller than the external diameter of the radial shoulder, plus a wall thickness of the non-deformed hose section, but is larger than the external diameter of the radial shoulder alone, so that the hose section is squeezed in the radial direction here, i.e., compressed, in particular elastically. A minimum internal diameter of the sleeve can be smaller in relation thereto, so that the recess of the sleeve can decrease in a curve or in steps between the section overlapping the radial shoulder and the minimum internal diameter.

In general, the internal diameter of the sleeve can be axially consistent, at least in sections. The internal diameter can similarly increase and/or decrease axially, in particular linearly, at least in sections. The recess of the sleeve can thus in particular have cylindrical and/or conical sections. The recess preferably has one or more edges in the peripheral direction, which prevent sliding of the sleeve on the hose section and thus improve the self-locking.

In an embodiment, one or more sealing means, in particular elastically deformed sealing elements, preferably O-rings, are arranged between pipe section and hose section. In an advantageous refinement, the sleeve overlaps at least one such sealing means in order to protect it from the outside. In a further embodiment, the sleeve has a radial recess in the area of an overlapped sealing means, in order to axially fix it. Additionally or alternatively, the minimum internal diameter can be smaller than an external diameter of the non-deformed sealing means plus a wall thickness of the non-deformed hose section, in particular smaller than the external diameter of the non-deformed sealing means. In this way, the sleeve clamps the sealing means between hose section and pipe section.

A pipe-hose arrangement is advantageously used in a motor vehicle, in particular in a vehicle air conditioner.

### BRIEF DESCRIPTION OF THE DRAWINGS

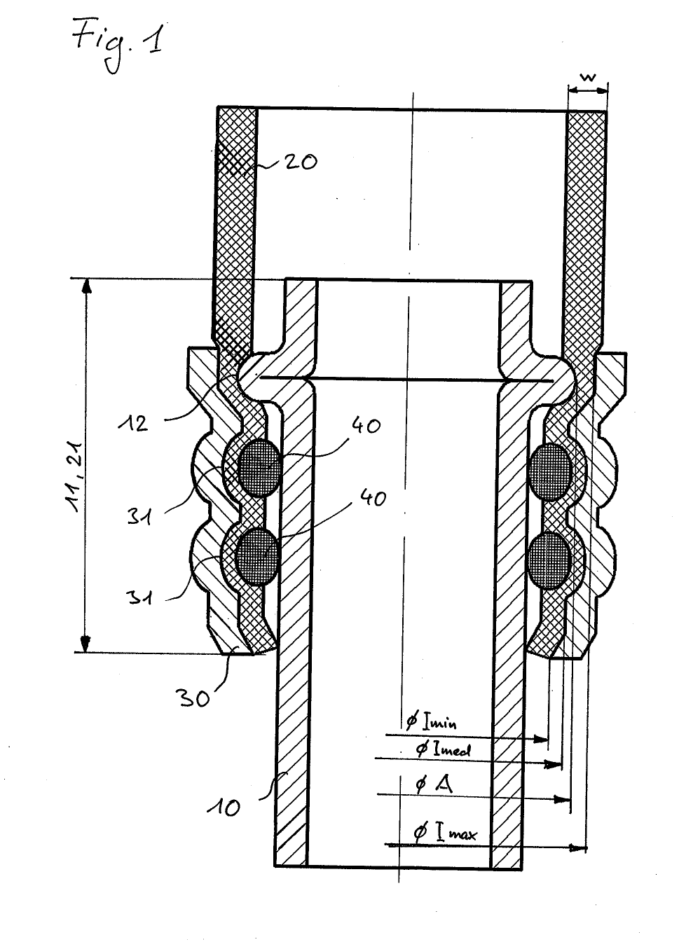

The present invention will hereinafter be described in conjunction with the following FIG. 1, which shows a pipe-hose arrangement according to an embodiment in an axial section.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows, in an axial section, a pipe-hose arrangement according to an embodiment having an aluminum pipe 10, whose frontal pipe section 11 is overlapped by a frontal hose section 21 of a rubber hose 20. The hose 20 can be an air-conditioning hose of a passenger automobile air conditioner, for example. The pipe section 11 has a radial shoulder 12 having an external diameter A, which has been implemented by axial compression of the aluminum pipe 10 close to its front side (on the right in FIG. 1) facing toward the hose 20. The hose section 21 was pulled over the shoulder 12 (from right to left in FIG. 1).

The entire axial length of an aluminum sleeve 30 overlaps the hose section 21. It was pushed onto the hose section 21 from a side of the radial shoulder which is axially opposite to a front side of the pipe facing toward the hose (on the left in FIG. 1), after the hose section had been pulled over the shoulder 12, and is arranged in the fastened state on this side of the shoulder 12. For this purpose, the sleeve 30 has a stepped through hole which accommodates the hose section 21. In a cylindrical section that overlaps the shoulder 12, this through hole has a maximum internal diameter Imax. The internal diameter tapers linearly therefrom to a cylindrical section having a medium internal diameter Imed, which is adjoined by a further linearly tapering, i.e., conical section, which ends, on the front side of the sleeve 30 opposite to the shoulder 12, in its minimum internal diameter Imin.

The medium internal diameter Imed and therefore particularly the minimum internal diameter Imin are smaller than the external diameter A of the radial shoulder 12. The maximum internal diameter Imax is smaller than the external diameter A of the radial shoulder 12 plus a wall thickness w of the non-deformed hose section. The hose section 21 is accordingly squeezed between the sleeve 30 and the radial shoulder 12 with elastic compression of the rubber hose material.

In the cylindrical section having medium internal diameter Imed, the sleeve 30 has two radial recesses 31, which have been implemented by a ring-shaped plastic deformation of the aluminum sleeve radially outward. Using these recesses 31, the sleeve 30 overlaps a sealing means in the form of an O-ring 40 in each case. The minimum internal diameter Imin is smaller than an external diameter of the non-deformed O-rings 40 plus the wall thickness w of the non-deformed hose section 21 and even smaller than the external diameter of the non-deformed O-rings 40 alone. The maximum internal diameter in the radial recesses 31 is also smaller than the external diameter of the non-deformed O-rings 40 plus the wall thickness w of the non-deformed hose section 21, so that the sleeve 30 clamps the O-rings 40 and the hose section 21 arranged between them and thus advantageously increases their sealing action.

If axial tension is exerted on the rubber hose 20 away from the aluminum pipe 10 (to the right in FIG. 1), the sleeve 30 overlapping the hose section 21 is pulled against the radial shoulder 12. Since, as explained above, it has the internal diameters Imax, Imed, or Imin, which are smaller than the external diameter A of the shoulder 12, possibly plus the wall thickness w of the non-deformed hose section 21, the hose section 21 is held in a self-locking manner between shoulder 12 and sleeve 30, since a stronger axial tension pulls the sleeve 30 more strongly against the shoulder 12 and therefore squeezes the hose section arranged between them more strongly. Through the elastic deformation of the hose section 21 between shoulder 12 and sleeve 30 and between the sleeve 30 and the O-rings 40, the hose 20 is also fixed in a friction-locked manner in the axially opposite direction (to the left in FIG. 1).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A pipe-hose arrangement, comprising:
a pipe;
a hose having a hose section facing toward the pipe, which overlaps a pipe section facing toward the hose, which has a radial shoulder having an external diameter; and
a sleeve at least partially overlapping the hose section on a side of the radial shoulder that is axially opposite to a front side of the pipe facing toward the hose and has a minimum internal diameter that is smaller than the external diameter of the radial shoulder plus a wall thickness of the hose section.

2. The pipe-hose arrangement according to claim 1, wherein the minimum internal diameter is less than the external diameter of the radial shoulder.

3. The pipe-hose arrangement according to claim 1, wherein the sleeve has a plurality of different internal diameters.

4. The pipe-hose arrangement according to claim 1, wherein the sleeve at least partially overlaps the radial shoulder.

5. The pipe-hose arrangement according to claim 1, wherein an internal diameter of the sleeve is axially consistent at least section ally.

6. The pipe-hose arrangement according to claim 1, wherein an internal diameter of the sleeve is increasing.

7. The pipe-hose arrangement according to claim 1, wherein an internal diameter of the sleeve is decreasing.

8. The pipe-hose arrangement according to claim 1, wherein at least one seal is arranged between the pipe section and the hose section.

9. The pipe-hose arrangement according to claim 1, wherein at least one elastically deformed sealing element is arranged between the pipe section and the hose section.

10. The pipe-hose arrangement according to claim 1, wherein the sleeve overlaps a seal.

11. The pipe-hose arrangement according to claim 1, wherein the sleeve in an area of an overlapping seal has a radial recess, the minimum internal diameter is less than the external diameter of a seal plus the wall thickness of the hose section

12. The pipe-hose arrangement according to claim 11, wherein the minimum internal diameter is less than the external diameter of the seal.

13. The pipe-hose arrangement according to claim 1, wherein the pipe comprises an aluminum

14. The pipe-hose arrangement according to claim 1, wherein the hose comprises a rubber.

15. The pipe-hose arrangement according to claim 1, wherein the hose comprises a plastic.

16. The pipe-hose arrangement according to claim 1, wherein the sleeve comprises an aluminum.

17. A method for producing a pipe-hose arrangement, comprising:
producing a radial shoulder by axial compression of a hose section;
axially moving the hose section over the radial shoulder; and
moving a sleeve from one side of the radial shoulder, which is axially opposite to the front side of a pipe facing toward a hose, onto the hose section.

18. The method according to claim 17, further comprising moving the hose applied to the sleeve axially toward the radial shoulder in order to clamp a wall section of the hose between the sleeve and the pipe.
